(19) United States
(12) Patent Application Publication
(10) Pub. No.: US 2005/0093193 A1
(43) Pub. Date: May 5, 2005

(54) In-line process and apparatus for making plaited synthetic twine

(75) Inventor: Paul Schmidt, Pretty Prairie, KS (US)

Correspondence Address: WOOD, PHILLIPS, KATZ, CLARK & MORTIMER, 500 W. MADISON STREET, SUITE 3800, CHICAGO, IL, 60661, US

(73) Assignee: Polymer Group, Inc.

(21) Appl. No.: 10/900,699

(22) Filed: Jul. 28, 2004

Related U.S. Application Data
(60) Provisional application No. 60/490,629, filed on Jul. 28, 2003.

(51) Int. Cl. B29C 47/58

(52) U.S. Cl. 264/103; 264/211.12; 264/211.21; 425/131.1; 425/382 R; 425/382.3

(57) ABSTRACT

The present invention is directed to the process of making synthetic cordage in a continuous manner, and more specifically, to an in-line process utilizing a compound extrusion manifold comprising two or more rotary die assemblies for continuously extruding and plaiting two or more polymeric filaments into a functional cordage such as twine, cord, or rope. The in-line process incorporates two or more rotary dies, wherein each rotary die comprises at least one extrusion orifice that is positioned within each of the individual dies so as upon rotation of each of the dies the continuously extruded filaments become intermingled and interlocked.

### TECHNICAL FIELD

The present invention generally relates to the process of making synthetic cordage in a continuous manner, and more specifically, to an in-line process utilizing a compound extrusion manifold comprising two or more rotary die assemblies for continuously extruding and plaiting two or more polymeric filaments into a functional cordage such as twine, cord, or rope.

### BACKGROUND OF THE INVENTION

While natural fibers have been used to make twine in the past, synthetic filaments are being used more frequently for the manufacture of twine, ropes, and cords due to the strength inherent to synthetic filaments, as well as their compatibility with automatic tying equipment. Typically, expansive sheets of synthetic material is extruded through a film-forming die, quenched in a water bath, and slit into desired widths, whereby the individual widths of material are separated and wound onto spools. Subsequently, the spools comprising the individual widths of slit material are then twisted together in a separate operation. Such a method is disclosed in U.S. Pat. No. 4,091,607, to Aspin, which is hereby incorporated by reference.

An additional method for processing twine is disclosed in U.S. Pat. No. 4,192,127, to O'Neil, et al. which includes wrapping a spiral band around parallel orientated monofilaments with a “false twist”. Again, filaments are formed in a separate operation, and then fed into a secondary apparatus which imparts the orientated filaments with a “false twist”, as well as a spiral band wrap.

U.S. Pat. No. 4,433,536, to O'Neil, refers to fibrillated synthetic ribbons, which are initially extruded as a continuous sheet through a film-forming die, quenched, and slit. The slits of ribbons are then fibrillated and fed into a spiral wrap rotating die apparatus that fuses a synthetic spiral band wrap around the orientated fibrillated ribbons.

The aforementioned processes of the prior art are complicated due to the multi-stepped operations and expensive equipment needed. A need remains for a process of making plaited twines, ropes, and cords by simplified and expedient means.

### SUMMARY OF THE INVENTION

The present invention is directed to the process of making synthetic cordage in a continuous manner, and more specifically, to an in-line process utilizing a compound extrusion manifold comprising two or more rotary die assemblies for continuously extruding and plaiting two or more polymeric filaments into a functional cordage such as twine, cord, or rope. The in-line process incorporates two or more rotary dies, wherein each rotary die comprises at least one extrusion orifice that is positioned within each of the individual dies so as upon rotation of each of the dies the continuously extruded filaments become intermingled and interlocked.

In accordance with the present invention each of the rotary dies may incorporate more than one extrusion orifice placed within the die to optimize the plaiting process of the continuously extruded filaments. The rotary dies may include orifices of dissimilar shapes or profiles so as to extrude filaments of varying cross-sections, such that for example one of the rotary dies, or one of the extrusion orifices with a rotary die comprising multiple extrusion orifices may extrude a filament that is circular in cross-section, while another extrusion orifice extrudes a flat, tape-like filament. The filaments may be of similar or dissimilar polymeric compositions. Suitable filaments, which may be blended in whole or part with natural or synthetic polymeric compositions. Synthetic polymeric compositions of preferable practice include polyamides, polyesters, polyolefins, polyvinyls, polyacrylics, and the blends or coextrusion products thereof. The synthetic polymers may be further selected from homopolymers; copolymers, conjugates and other derivatives including those thermoplastic polymers having incorporated melt additives or surface-active agents.

Further, the compound extrusion manifold may incorporate the use of one or more stationary dies, whereby two or more rotary dies rotate about one or more centrally located stationary dies. Again, the stationary die(s) may include more than one extrusion orifice of optionally dissimilar shapes so as to extrude filaments of varying cross-sections. Each of the the rotary dies themselves are driven by a motorized force that rotates the rotary dies in unison within the compound extrusion manifold. While the rotary dies rotate in set relationship with one another, the extruded filaments are plaited to form cordage such as a twine, cord, or rope material.

In one embodiment, the rotary die may accept a stack plate die insert. Co-pending application U.S. Ser. No. 60/462,054, filed Apr. 11, 2003, to Krause, et al., teaches to such stack plate die, which is hereby incorporated by reference. The stack plate die insert may be utilized alone or in combination with additional rotary and/or stationary dies. Furthermore, a single rotary die may comprise the stack plate insert as well as one or more additional orifices for filament extrusion.

It is within the purview of the present invention that the rotary dies may be similar or dissimilar in shape. In a preferred embodiment, the rotary dies are circular in circumference; however the rotary dies may be oval or of other peripheral profiles. It is believed that the various rotary die shapes, in addition to the extruded filament compositions and cross-sections, contribute to the over all plaiting pattern of the twine, cord, or rope, affecting the physical properties of the material.

The multiple rotary die, compound extrusion manifold of the present invention processes a cordage material in-line without the need for separate spinning and twisting operations. A process for making twine material in accordance with the present invention entails extruding continuous filaments and twisting or plaiting the filaments as the filaments are extruded from the rotary dies. Subsequently, the plaited filaments are quenched, drawn, and wound, which results in a cordage material that can be produced at a faster rate of speed.

### BRIEF DESCRIPTION OF THE DRAWINGS

FIG. 1 is a schematic representation of the processing apparatus for producing a cordage material in accordance with the principles of the present invention;

FIG. 2 is a schematic representation of an embodiment of the rotary die head utilized in accordance with the present invention;

FIG. 3 is a schematic representation of an embodiment of the rotary die head utilized in accordance with the present invention;

FIG. 4 is a schematic representation of an embodiment of the rotary die head utilized in accordance with the present invention;

FIG. 5 is a schematic representation of an embodiment of the rotary die head utilized in accordance with the present invention;

FIG. 6 is a schematic representation of an embodiment of the rotary die head utilized in accordance with the present invention;

FIG. 7 is a schematic representation of an embodiment of the rotary die head utilized in accordance with the present invention;

FIG. 8 is a schematic representation of an embodiment of the rotary die head utilized in accordance with the present invention;

FIG. 9 is a schematic representation of an embodiment of the rotary die head utilized in accordance with the present invention; and

FIG. 10 is a schematic representation of an embodiment of the rotary die head utilized in accordance with the present invention.

### DETAILED DESCRIPTION

While the present invention is susceptible of embodiment in various forms, there will hereinafter be described, presently preferred embodiments, with the understanding that the present disclosure is to be considered as an exemplification of the invention, and is not intended to limit the invention to the specific embodiments disclosed herein.

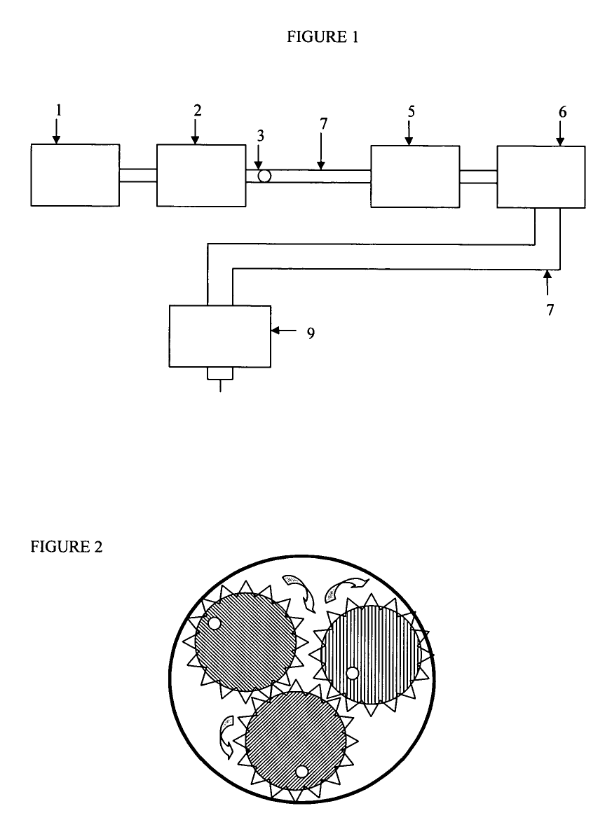

FIG. 1 depicts a representative direct extrusion film process. Blending and dosing system 1, comprising at least two hopper loaders for polymer chip and a mixing hopper. Variable speed augers within both hopper loaders transfer predetermined amounts of polymer chip and additive pellet to the mixing hopper. The mixing hopper contains a mixing propeller to further the homogeneity of the mixture.

The polymer chip and additive pellet blend feeds into a multi-zone extruder 2 as supplied by the Wellex Corporation. In this particular system, a five zone extruder was employed with a 2 inch water-jacketed bore and a length to diameter ratio of 24 to 1.

Upon mixing and extrusion from multi-zone extruder 2, the polymer compound is conveyed via heated polymer piping 7 through screen changer 3, wherein breaker plates having different screen meshes are employed to retain solid or semi-molten polymer chips and other macroscopic debris. The mixed polymer is then fed into melt pump 5.

Melt pump 5 operates in dynamic feed back with the multi-zone extruder 2 to maintain the desired pressure levels. A gear-type melt pump was employed to respond to pressure levels by altering the speed of the extruder to compensate for deviations from the pressure set point window.

The metered and mixed polymer compound then enters combining block 6. The combining block allows for multiple film layers to be extruded, the film layers being of either the same composition or fed from different systems as described above. The combining block 6 is directed into rotary die body 9 by additional heated polymer piping 7.

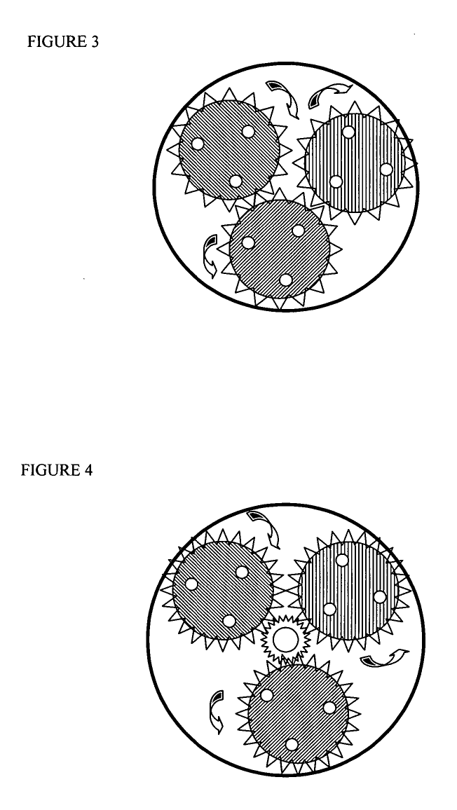

The various die bodies that may be employed in this system are illustrated in FIGS. 2-7. The rotary die body embodiment represented in FIG. 2 illustrates three rotary dies, each with a single extrusion orifice exit, wherein the three rotary dies rotate in unison by a driving force that encompasses the periphery of the rotary dies. Suitable driving force means include, but are not limited to motorized belts, chains, and pulley systems. It has been contemplated that each rotary die comprise more than one extrusion orifice exit. FIG. 3 is representative of such an embodiment.

It is within the purview of the present invention that each rotary die may extrude continuous filaments of similar composition or dissimilar composition. Suitable synthetic resins, which may be blended in whole or part, include polyamides, polyesters, polyolefins, polyvinyls, polyacrylics, and the combinations thereof. The polymers may be further selected from homopolymers; copolymers, conjugates and other derivatives including those thermoplastic polymers having incorporated melt additives or surface-active agents. In addition, each extrusion orifice may extrude a continuous filament of similar or dissimilar cross-sections, wherein one orifice may extrude a filament that is circular in cross-section, while another orifice extrudes a flat, tape-like filament.

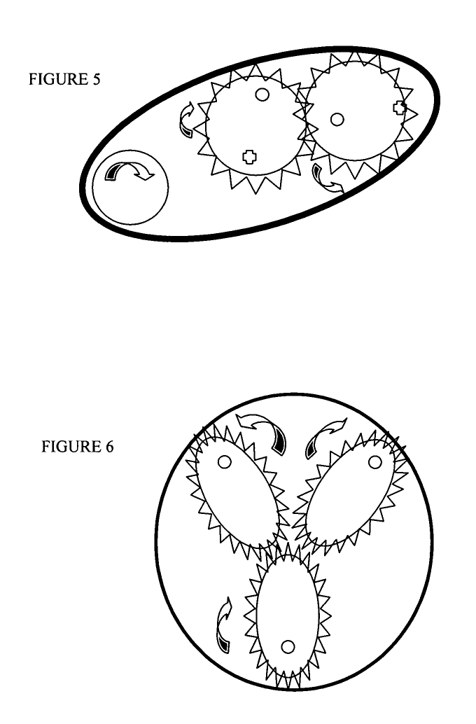

FIG. 5 is a schematic representation of an embodiment of the rotary die of the present invention, wherein each rotary die is comprised of more than one extrusion orifice exit. Further, each extrusion orifice exit within each die comprises a dissimilar orifice shape so as to extrude continuous filaments of dissimilar cross-sections.

Optionally, the rotary dies of the present invention may be utilized in combination with one or more stationary dies. FIG. 4 illustrates the rotary dies of the present invention rotating in unison along a centrally located stationary die. In such an embodiment, the extruded continuous filaments dispensed from the rotary dies are plaited about a centrally extruded continuous filament. The various continuous filaments dispensed from the various dies may comprise a vast range of deniers, depending on the end-use of the processed twine material. It has also been contemplated that the rotary dies of the present invention accept one or more stack plate die inserts. Further, the rotary dies may be used in combination with both stationary dies and stack plate die inserts.

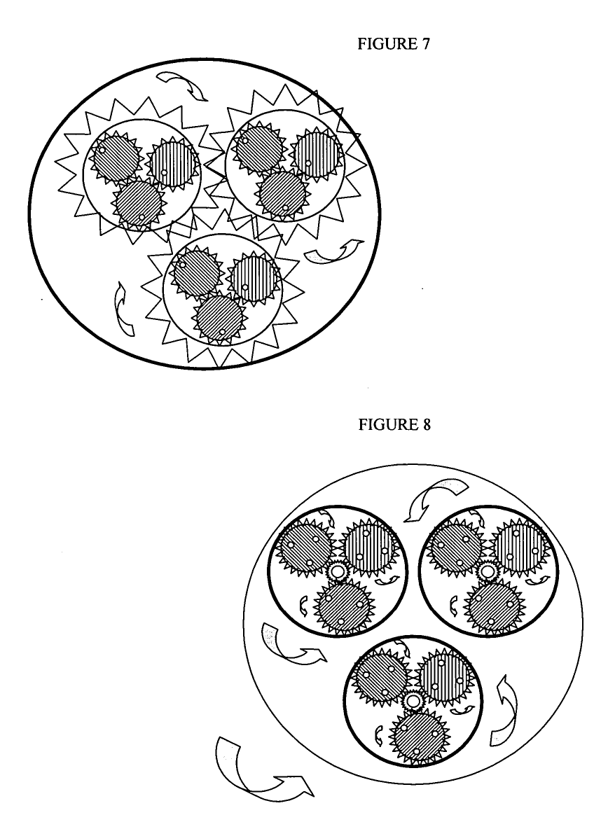

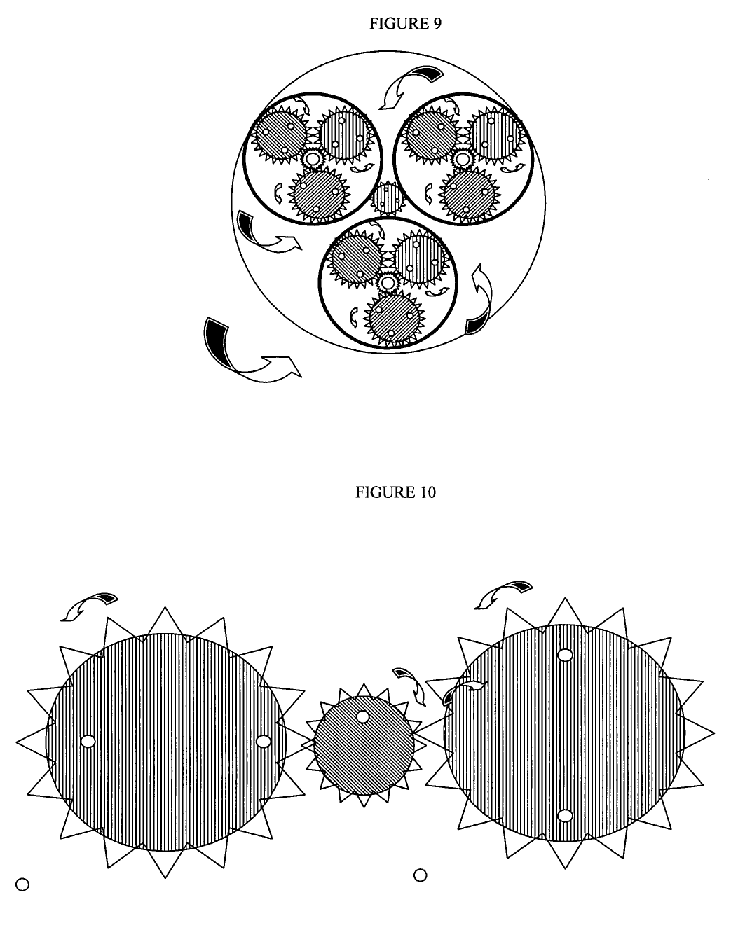

FIG. 6 depicts the use of non-circular shaped rotary dies. In accordance with the present invention the rotary dies may be of various shapes, whereby the rotary dies may all consist of the same shape or different shapes. Additionally, the rotary dies may be compounded as demonstrated in FIGS. 7-9. In this embodiment, plaited filaments extruded from each rotary die are plaited again to form a compoundly plaited twine material. Further, as in FIG. 10, a rotary die assembly may comprise a centrally located die that extrudes one or more filaments interconnecting the filaments extruded from the two or more surrounding rotary dies. Optionally, the centrally located die may be a stationary die or rotary die. The collection of die assemblies may operate at one or more speeds to achieve a desired effect in the resultant twine material.

Subsequent to formation, the twine material may optionally be subjected to various chemical and/or mechanical post-treatments. The twine material is then collected and packaged in a continuous form, such as in a roll form, or alternatively, the twine material may comprise a series of weak points whereby desired lengths of twine material may be detracted from the remainder of the continuous packaged form.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

1. An apparatus for continuously extruding and plaiting twine material in an in-line process wherein said apparatus comprises two or more rotary dies that extrude one or more polymeric resins through one or more extrusion orifice exits; said dies driven by a motorized force to rotate said dies in unison with one another plaiting said extruded polymeric resin into said twine material.

2. An apparatus as in claim 1, wherein said rotary dies comprise a stationary die.

3. An apparatus as in claim 1, wherein said rotary dies comprise a stack plate die insert.

4. An apparatus as in claim 1, wherein said rotary dies operate at one or more speeds.

5. An apparatus as in claim 1, wherein said extrusion orifice exits extrude polymers of dissimilar cross-sections.

6. An apparatus as in claim 1, wherein said rotary dies are compounded.

7. A process for making a plaited twine material in-line comprising the steps of:
a. providing two or more rotary dies comprising at least one extrusion orifice exit, wherein said dies are rotated by a motorized force;
b. providing at least a one polymeric resin;
c. extruding said polymeric resin from said rotating rotary dies thereby plaiting said polymeric resin into said twine material; and
d. collecting said twine material.

8. A process for making a plaited twine material in-line comprising the steps of:
a. providing two or more rotary dies comprising at least one extrusion orifice exit, wherein said dies are rotated by a motorized force;
b. providing one or more stationary dies;
c. providing at least a one polymeric resin;
d. extruding said polymeric resin from said rotating rotary dies and stationary dies thereby plaiting said polymeric resin into said twine material; and
e. collecting said twine material.
